(19) United States
(12) Patent Application Publication
(10) Pub. No.: US 2004/0085300 A1
(43) Pub. Date: May 6, 2004

(54) Device and method for selecting functions based on intrinsic finger features

(76) Inventor: Alec Matusis, Stanford, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/620,846

(22) Filed: Jul. 15, 2003

Related U.S. Application Data
(63) Continuation-in-part of application No. 09/847,977, filed on May 2, 2001, now Pat. No. 6,603,462.

(51) Int. Cl. G09G 5/00

(52) U.S. Cl. 345/173

(57) ABSTRACT

A device and method for selecting functions based on intrinsic finger features that includes a finger features database storing finger features and corresponding functions. The device further includes a finger feature sensor, an identification engine and a response or actuation engine. The identification engine matches the feature with stored features. The response engine then identifies a function in the table corresponding to a matched feature. The response engine can then forward an instruction corresponding to the identified function to a device for execution. The device and method also provides for user identification and authorization of executing functions or commands.

### PRIORITY REFERENCE TO PRIOR APPLICATIONS

This application is a continuation in part based on U.S. patent application Ser. No. 09/847,977 filed May 2, 2001.

### FIELD OF THE INVENTION

This invention relates generally to input devices, and more particularly, but not exclusively, provides a device and method for selecting functions based on finger features.

### BACKGROUND

Generally, conventional input keypads and keyboards only allow performance of a single function per key. For example, to display the letter “s” on a computer screen, a user must press the “s” key on a keyboard. In order to increase the number of functions selectable via a keyboard, a key combination must be pressed. For example, to display a capital character, e.g., “S”, instead of a lower case character, e.g., “s”, the user must press two keys simultaneously, e.g., “Shift” and “s”.

While the above-mentioned method may be an acceptable way of selecting functions using a keyboard, it is undesirable in small devices where space is at a premium and where it may be hard to distinguish between keys. For example, in a mobile phone, the space available for a keypad is limited. Accordingly, in order to increase the number of keys on a keypad, the keys are made extremely small thereby making it hard for a user to distinguish between keys.

To assist cell phone users when storing names and corresponding telephone numbers in the cell's phonebook, cell phone designers have linked specific characters to each of the keys on the cell phone keypad. Users can depress a particular key multiple times to shift through characters available by the particular key. For example, to enter the name of “Jim” on a cell phone, the user must depress the “5” key once, the “4” key three times, and the “6” key once. This can be quite a cumbersome process.

Another problem with conventional input devices is that, when the input devices are installed into vehicles, it is generally unsafe for an operator of the vehicle to temporarily cease viewing outside of the vehicle in order to input instructions with the conventional input device. For example, in order to operate a radio receiver, a driver of a car may cease watching for oncoming traffic thereby leading to possible safety hazards due to the driver's inattention to traffic conditions.

Accordingly, new techniques are desirable that are generally amenable to input devices without limiting input functionality and/or input devices that can be used without viewing the devices.

Additionally, it is sometimes desirable to be able to identify which user has inputted a certain command, or performed a particular operation, or to restrict certain users from being able to input commands.

### SUMMARY

The present invention provides an example system for an input device that allows selection of functions based on intrinsic finger features or characteristics, where a single user uses several fingers to select between the plurality of functions. A finger feature may include a fingerprint, shape of an individual fingernail while a finger characteristic may include data extracted from a finger feature, such as minutiae points or a pattern of the texture of the skin.

An exemplary embodiment could include one finger feature sensor, a processor, a memory device, and an input/output (“I/O”) interface, all interconnected for example by a system bus. The sensor reads a feature of a finger, for example, a fingerprint, or the shape of the fingernail, and feeds the feature to the processor. The processor executes instructions in memory for determining a function based on an analysis and identification of the finger. The processor then forwards an instruction corresponding to the determined function to a device for execution.

The present invention further provides a method of selecting a function using the input device based on a finger feature, where a single user uses several of such fingers to select between the plurality of functions. The method comprises the steps of receiving a finger feature from a sensor; finding the closest finger feature match in a database (typically stored in a memory) of finger features/characteristics and corresponding functions; and then sending a function command corresponding to the closest matched finger feature to a device for execution.

Accordingly, the device and method allows for replacing a conventional keypad with an embodiment of the present invention with fewer keys. For example, a conventional mobile phone keypad may have ten keys for the numbers 0-9. Using an embodiment of the invention would allow for replacing the ten keys with a single sensor. In the human hand embodiment, each finger of a user's two hands would then be able to activate a different number. For example, the left pinkie finger may be used to indicate “0”, the left ring finger may indicate “1”, and so forth. Or, a single button on the earpiece of the hands-free kit of a mobile phone can be used for dialing three different numbers, where dialing each number corresponds to touching the button with a particular finger.

In another exemplary embodiment, a dashboard of a vehicle having multiple buttons could be replaced with a single large sensor. For example, different radio presets can be controlled through a single button. Accordingly, a driver could activate different functions by pressing the sensor with a finger corresponding to function wanted, thereby eliminating the need of examining a conventional dashboard to identify the correct button to press. Further, a driver may not be able to operate a dashboard device while driving due to the inability to see buttons due to darkness. Accordingly, using this embodiment of the invention enables a driver to select functions in a dashboard device without the need to identify individual buttons in darkness.

In yet another embodiment, a viewfinder used for aiming and targeting a weapon is equipped with a large sensor on its side. By touching this sensor with different fingers, the operator can perform different functions while looking in the viewfinder. Moreover, since the sensor reads the specific features of the operator's fingers, it is possible at a future time to identify the operator who issued particular commands or functions, or allow only a pre-authorized set of operators to issue commands or functions, thus rendering the system unusable if it falls into enemy's hands.

To further extend the functionality of the input device, the selection of a function may depend on both the finger which touches the input device, and the motion of this finger relative to the input device. An example of this embodiment is a laptop trackpad. For example, to drag-and-drop a desktop item on a computer desktop, the user first moves the cursor on top of the item my moving his index finger relative to the touchpad, then when the cursor is on top of the item, the user selects and drags it by moving the middle finger relative to the trackpad. Touching the trackpad with the ring finger when the cursor is above the item may correspond to the function “delete”.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a device embodiment;

FIG. 2 is a block diagram illustrating an input system;

FIG. 3 is a block diagram illustrating contents of a memory device of the system of FIG. 2;

FIGS. 4A-4C are block diagrams of alternative embodiments of a sensor;

FIG. 5 is a diagram illustrating contents of finger feature table located in the memory device of FIG. 3;

FIG. 6 is a diagram illustrating contents of a finger feature table located in the memory device of FIG. 3 according to another embodiment of the invention; and

FIG. 7 is a flowchart of a method to select functionality of a button based on a finger feature.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

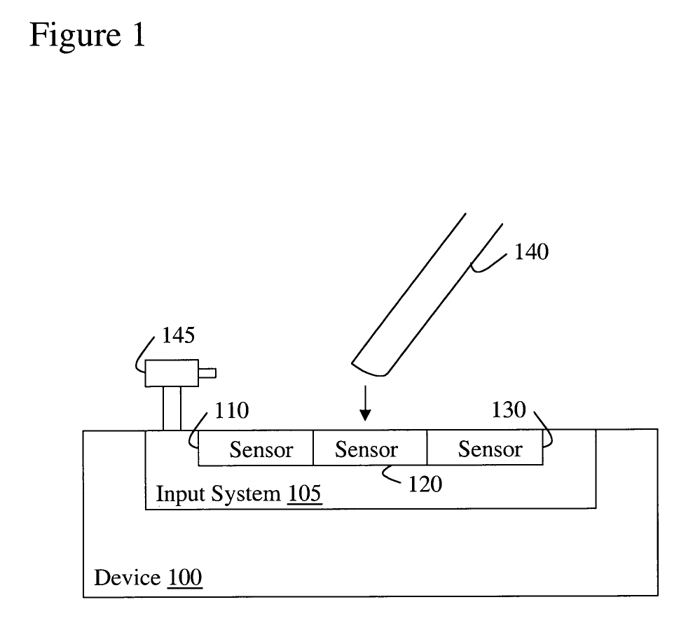

FIG. 1. is a block diagram illustrating a device 100 for use with an embodiment of the invention. Device 100 is coupled to input system 105. Device 100 may include an audio system, a mobile phone, a computer, a dashboard of a vehicle, a cockpit, a machine, a handheld computer, a medical device, a wearable computer, a camera, a video game controller, a wireless earpiece of a cellular phone hands-free kit, any device where the operator cannot see the controls while looking through the device, or any other device that makes use of an input control system. Input system 105 includes a sensor 110, a sensor 120, a sensor 130 and an optional (also referred to as additional) sensor 145. Note that the input system 105 must have at least one sensor and the present invention is not limited to a small or large number of sensors. Sensors 110-130 and optionally 145 read finger features, such as fingerprints. Sensors 110-130 may also read other data such as coordinates touched (coordinates on a sensor surface touched by a finger) and motion (movement of a finger along a sensor surface), including character recognition. Optional sensor 145 can read other finger features, such as the shape of the fingernail, or the texture or pattern of the finger skin, using a CMOS or a CCD image sensor. Optional sensor 145 may continuously scan for finger features or may only be activated when a user touches one of sensors 110-130.

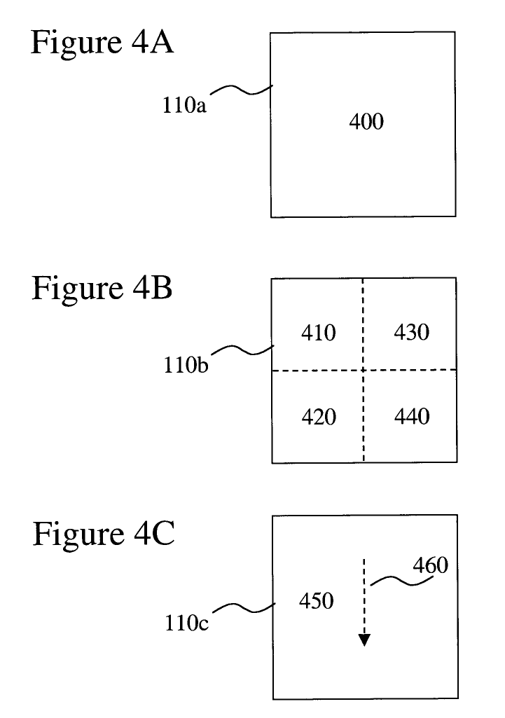

Based on finger feature matching and optionally on coordinate and/or motion analysis, system 105 sends a corresponding command, instruction or function to device 100 as a function of the matched finger feature, and of the optional coordinate and/or motion analysis. For example, if sensor 120 measures a feature of finger 140 indicating that finger 140 is an index finger, then system 105 may send a particular instruction to display the number “7.” Alternatively, if finger 140 is a ring finger, then system 105 may send an instruction to device 100 to display the number “9.” Sensors 110-130 and 145 will be discussed in further detail in conjunction with FIGS. 4A, 4B and 4C.

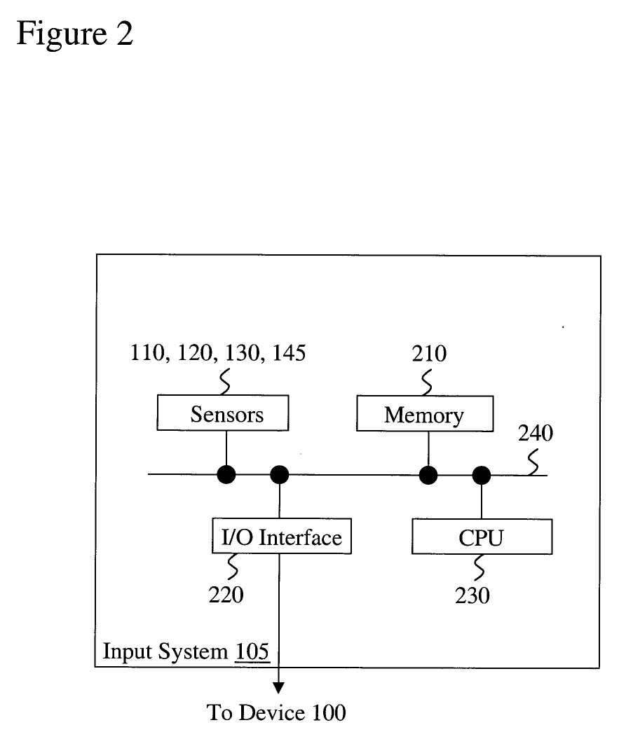

FIG. 2 is a block diagram illustrating the input system 105. The system 105 includes a central processing unit (“CPU”) 230, such as an Intel Pentium® microprocessor or a Motorola Power PC® microprocessor, communicatively coupled to, for example, a system bus 240. The system 105 further includes input sensors 110, 120, 130, and 145 that read finger features, such as fingerprints, I/O interface 220, which is communicatively coupled to device 100, and memory 210 such as a magnetic disk, Random-Access Memory (“RAM”), or other memory device or a combination thereof, each communicatively coupled to the system bus 240. One skilled in the art will recognize that, although the memory 210 is illustrated as an integral unit, the memory 210 can be one or more distributed units. In another embodiment, system 105 may be fully integrated into device 100 so that both system 105 and device 100 use only CPU 230 and memory 210 for all processing and data storage respectively.

Accordingly, I/O interface 220 would be optional. Yet in another embodiment, instead of the CPU and RAM connected by a system bus, a single dedicated DSP (Digital Signal Processing) chip may be used. It will be appreciated that, although some elements (including steps) are labeled herein as optional, other elements not labeled optional may still be optional.

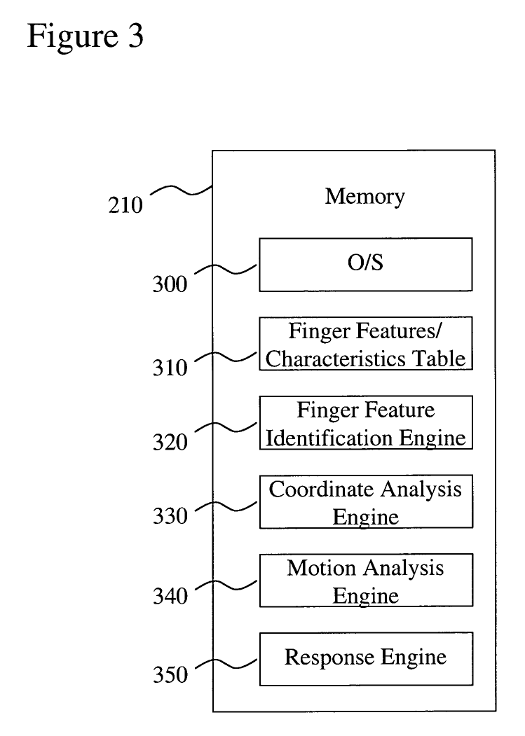

CPU 230 executes instructions stored in memory 210 for receiving finger feature data from a sensor, generating a closest match of finger feature data to finger feature data stored in a table 310 (FIG. 3) in memory 210, and then sending a function command stored in the table 310 corresponding to the closest match to the device 100. In an alternative embodiment, CPU 230 executes instructions stored in memory 210 for receiving finger feature data from a sensor; identifying finger characteristics, such as minutiae points, from the feature data; generating a closest match of finger characteristic data to finger characteristic data stored in a table 310 (FIG. 3) in memory 210, and then sending a function command stored in the table 310 corresponding to the closest match to the device 100. Memory 210 and the instructions stored therein will be discussed in further detail in conjunction with FIG. 3.

Sensors 110, 120, 130, and 145 may read several different types of finger features besides fingerprints. For example, sensors 110, 120, 130, and 145 may read the shape of the fingernails, or the texture and the pattern of the skin just above the fingernail, and may therefore comprise CMOS or CCD sensors. Sensors 110, 120, 130 may also be capable of reading coordinates of a finger touching a sensor and/or motion of a finger along a surface of a sensor.

The sensors 110, 120, 130, and 145 may also each read the same finger features or may each read different finger features. Alternatively, each sensor may read multiple types of finger features. For example, sensors 110-130 may all read fingerprints or sensors 110, 120 may read fingerprints while sensor 130 may read fingertip color. In another embodiment, sensors 110-130 may read both fingerprints and fingertip color. Examples of commercially available fingerprint sensors include the AuthenTec, Inc. EntréPad™ AES4000™ sensor and the ST Microelectronics TCS1A sensor. In another embodiment, sensors 110-130 may include touch pads or touch screens. Sensors 110-130 will be discussed in further detail in conjunction with FIGS. 4A-4C.

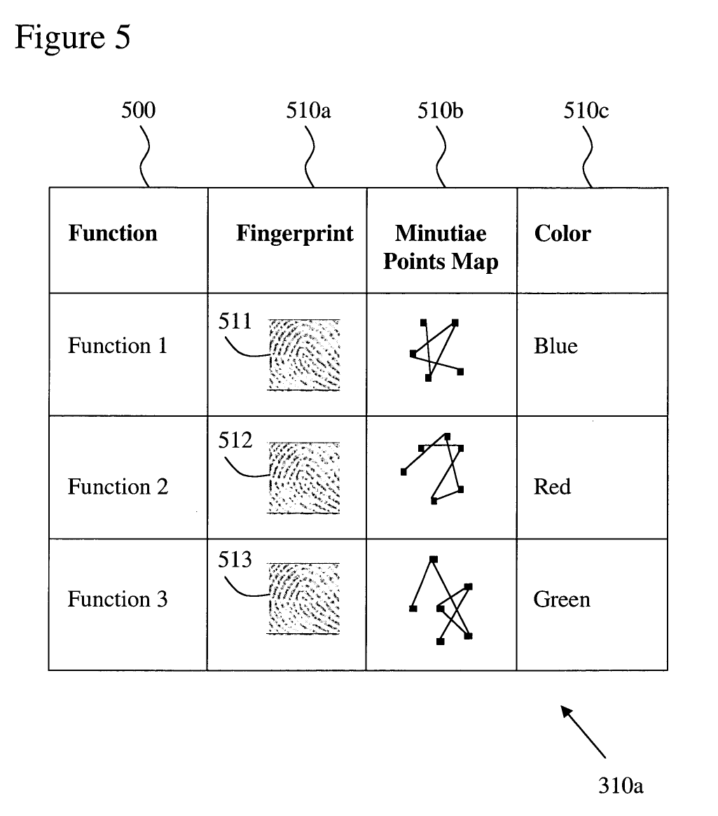

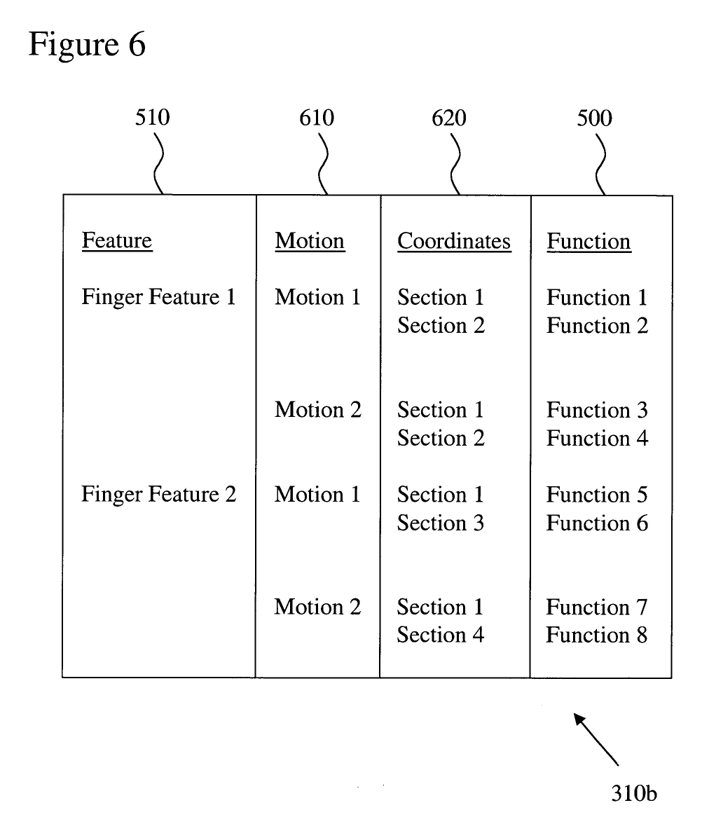

FIG. 3 is a block diagram illustrating contents of memory 210, which includes an operating system (“O/S”) 300, such as Linux or other operating system, a finger features/characteristics table 310, a finger feature identification engine 320, an optional coordinate analysis engine 330, an optional motion analysis engine 340, and a response engine 350. Finger features/characteristics table 310 holds a table of finger features and/or characteristics and associated commands and will be discussed in further detail in conjunction with FIGS. 5 and 6.

Finger feature identification engine 320 analyzes finger feature data from sensors 110-130 and generates a closest match of the finger feature data to finger features stored in finger features/characteristics table 310. Identification engine 320 may use a correlation matcher algorithm, or other algorithm, depending on the type of finger feature measured by sensors 110-130. In an alternative embodiment, identification engine 320 may identify finger characteristics, such as minutiae points, from received finger feature data and generate a closest match of the identified finger characteristics to finger characteristics stored in table 310 using a minutiae point matching algorithm in the case of minutiae points, and/or other algorithm.

Coordinate analysis engine 330 determines coordinates of a user's finger touching a sensor, such as sensor 110. For example, a sensor can be divided into several virtual areas and the coordinate analysis engine 330 can identify which virtual area a user's finger has touched. Motion analysis engine 340 analyzes motion of a finger along a sensor surface and may include character recognition technology. Response engine 350 then, based on the closest matched finger feature or characteristic, and optionally on coordinate analysis results and/or motion analysis results, generates a response corresponding to the above-mentioned results as stored in finger features/characteristics table 310. The response engine then may forward the generated response to device 100. The generated response may include a command, such as a command to disable device 100.

FIGS. 4A-4C are block diagrams of alternative embodiments of sensor 110. Sensor 110a may include a conventional fingerprint sensor such as AuthenTec, Inc. EntréPad™ AES4000™ sensor. Sensor 110a scans a fingerprint when a user's finger touches sensor 110a surface 400. Sensor 110b shows an embodiment of sensor 110, wherein the surface of the sensor is divided into virtual areas or quadrants 410, 420, 430 and 440. Sensor 110b, in addition to having the ability of scanning a fingerprint, can also read coordinates, which can include determining which virtual quadrant was touched by a finger. Sensor 110c, in addition to fingerprint scanning, can perform motion measurement of a finger along the surface of the sensor 110c. For example, a finger moving from the top of the sensor 110c surface to the bottom of the sensor 110c surface, as indicated by arrow 460, can be measured. In addition, sensor 110c may be able to perform coordinate measurement.

FIG. 5 is a diagram illustrating details of a finger feature/characteristic table 310a located in the memory 210. It will be appreciated that, although the structure of element 310a is being described as a table, one skilled in the art will recognize that other database structures can be used such as linked lists. Table 310a is for a single sensor and includes a single set of functions 500 and a single set of corresponding finger features, such as fingerprints 510a or color 510c. Alternatively, table 310a may include a single set of corresponding finger characteristics, such as minutiae points maps 510b. While table 310a only comprises a set of three functions, any number of functions and corresponding finger features or characteristics may be stored in table 310a. In addition, different users may have finger features stored in table 310a thereby allowing multiple users to use a single device. In this case, a user who selected a particular function of the device can be identified, of which a record may be created and stored in the memory. The sets of functions corresponding to a user's fingers can be different for different users. The device operation can be authorized only to a pre-determined set of users.

In order to store finger features or characteristics 510 into table 310a, a user stores finger features or characteristics 510 into table 310a using an optional initiation engine (not shown) that can be stored in memory 210. The initiation engine uses sensors 110-130 and/or 145 when appropriate, to scan finger features into the table 310a. Alternatively, some finger features 510 can be preprogrammed into table 310 before distribution of device 100 to users.

In operation, if a user, for example, touches a finger feature sensor associated with table 310a, the sensor will scan the user's finger feature and then finger features identification engine 320 will look up the closest matching finger feature in table 310a. Accordingly, if the identification engine 320 determines the closest match is fingerprint 511, then response engine 350 will forward the function 1 command to device 100. If the closest match is fingerprint 513, then the response engine 350 will forward the function 3 to device 100.

FIG. 6 is a diagram illustrating contents of a finger feature/characteristic table 310b located in the memory 210. Table 310b not only includes a set of finger features 510, but also includes motion datasets 610 and coordinates 620. Accordingly, determination of a function from functions 500 is based on not only finger features 510, but also motion datasets 610 and coordinates 620.

Accordingly, during operation of a sensor associated with table 310b, the sensor will first read a finger feature, then read motion characteristics as a finger moves along the sensor surface, and then also read origin coordinates of where a finger originally touched the sensor. Alternatively, the measurements of finger feature, motion characteristics, and coordinates can take place in a different order. Therefore, the sensor associated with table 310b allows for eight different functions as compared to a conventional button that might only allow for a single function.

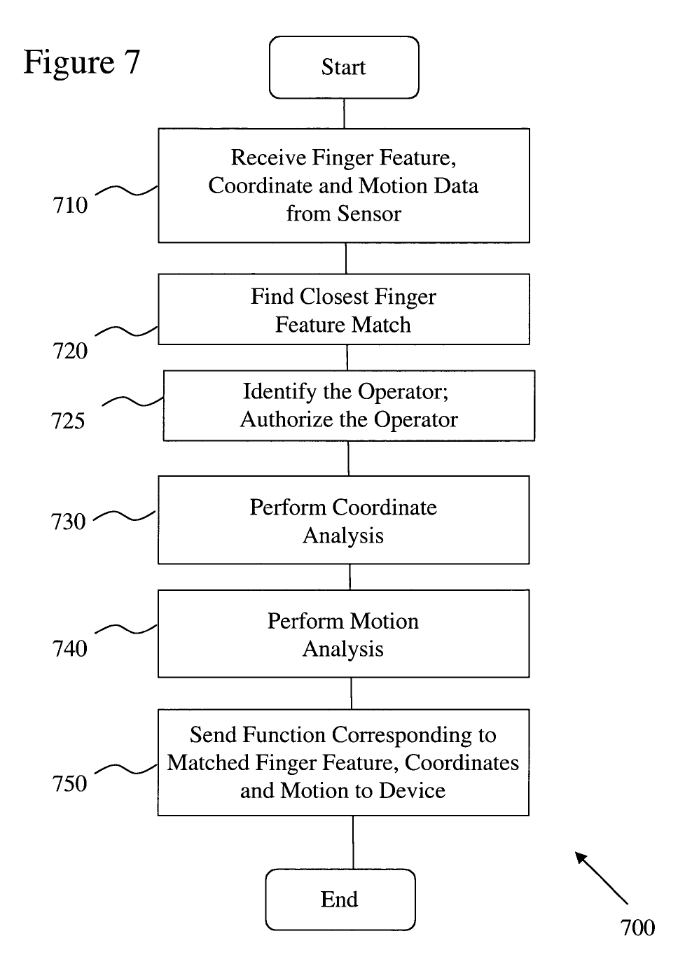

FIG. 7 is a flowchart of a method 700 to alter the functionality of a button based on finger feature identification and other factors. Note that method 700 runs continuously and several instances of method 700 may be running at one time to process data from several sensors and/or to process multiple data received from a single sensor. In one embodiment, method 700 can be performed by identification engine 320, coordinate analysis engine 330, motion analysis engine 340 and response engine 350. First, a finger feature and optionally, coordinate and motion data, from a sensor, such as sensor 110, are received 710. Next, finger feature identification is performed 720, by, for example, finger feature identification engine 320 by matching the received finger feature with a stored finger feature in table 310. In an alternative embodiment, in place of finger feature identification 710, finger characteristic identification may be performed, which includes identifying finger characteristic data from the received finger feature and then matching the identified characteristic data with stored finger characteristic data in table 310.

Then, the user identification could be optionally performed 725 by looking up the name/identification (ID) of the user whose finger features stored in table 310 correspond to the received finger feature. If the matching user is found, his name/ID can be stored in the memory in association with the function that he selected 750 to future identify who selected a particular function 750. The sets of functions (500) corresponding to finger features 510 may be different for different users. In this case, adding additional users amounts to adding new entries (510, 500 and optionally 610 and 620) to the table 310b. If the received feature 500 is not in the table 310, a default function (which may be no function) is selected.

Next, coordinate analysis is optionally performed 730, by, for example, coordinate analysis engine 330 by matching the received coordinate data with coordinates, or a region of coordinates in table 310. Next, motion analysis is optionally performed 740 by, for example, motion analysis engine 340 by matching the received motion data with motion data stored in table 310. Note that motion analysis may also include character recognition. In an alternative embodiment, finger feature identification, coordinate analysis and motion analysis can be performed in alternative orders.

After finger feature identification 720 and optional user 725, coordinate 730 and motion analysis 740, a function from table 310 corresponding to the matched finger feature or characteristic, optional coordinate and optional motion data is sent 750 to a device, such as device 100. For example, in one embodiment response engine 350 may send a function corresponding to the matched data to device 100. If device 100 is a mobile phone, the function may include dialing the phone, terminating a call, increasing speaker volume, etc. Accordingly, in a small mobile phone, only a single sensor may be needed to implement many different input functions as compared to a conventional ten or more button keypad.

The foregoing description of the illustrated embodiments of the present invention is by way of example only, and other variations and modifications of the above-described embodiments and methods are possible in light of the foregoing teaching. For example, system 105 and device 100 may be fully integrated such that only one CPU 230 and memory device 210 would be needed for both. One skilled in the art should note that the terms “pressing” or “depressing” with regard to keys or buttons should not be limited to buttons or keys that physically depress. Further, components of this invention may be implemented using a programmed general-purpose digital computer, using application specific integrated circuits, or using a network of interconnected conventional components and circuits. Connections may be wired, wireless, modem, etc. As a person skilled in the art would appreciate is that the present invention is not limited to small sensors or large sensors such as a touchscreen. All such variations are considered to be within the scope and spirit of the present invention as defined by the following claims and their legal equivalents.

What is claimed is:

1. A device for selecting functions, comprising:
(a) a memory wherein stored a one to one relationship between two or more fingers of a user and multiple functions, each of the two or more fingers of the user have a different intrinsic finger feature associated therewith, the intrinsic features are features that are natural to the fingers and are not brought about by any modifications to the fingers; and
(b) a fixed and discrete location is simultaneously associated with the multiple functions, and wherein the selection of desired functions is achieved by the user alternating the different fingers at the fixed and discrete location; and
(c) a sensor capable of obtaining a finger feature from the fixed and discrete location.

2. The device as set forth in claim 1, further comprising a means to identify the user.

3. The device as set forth in claim 1, wherein the memory comprises a pre-authorized set of users who are allowed to select one or more of the multiple functions.

4. The device as set forth in claim 1, wherein the memory has stored for multiple users different one to one relationships.

5. The device as set forth in claim 1, wherein the device is an audio system, a mobile phone, a computer, a handheld computer, a medical device, a machine, a dashboard of a vehicle, a cockpit, a camera, a video game controller, a wireless earpiece of a cellular phone hands-free kit, or a device where the user cannot see the controls while looking through the device.

6. The device as set forth in claim 1, wherein the finger feature comprises fingerprint data, finger shape data, fingernail shape data or finger texture data.

7. The device as set forth in claim 1, wherein the one to one relationship between the intrinsic finger features and the multiple functions comprises motion data from the fixed and discrete location of the sensor and wherein the device further comprises a motion data analysis means.

8. The device as set forth in claim 7, wherein the motion data is related to functions in a computer program.

9. The device as set forth in claim 7, wherein the motion analysis means comprises character recognition means.

10. The device of claim 1, wherein the one to one relationship between the intrinsic finger features and the multiple functions comprises coordinate data from the fixed and discrete location of the sensor and wherein the device further comprises a coordinate data analysis means.

11. The device as set forth in claim 1, wherein the sensor comprises a trackpad.

12. The device as set forth in the claim 1, wherein the sensor comprises a touchscreen.

13. The device as set forth in claim 1, wherein the sensor comprises virtual areas.

14. A method for selecting functions, comprising:
(a) providing a one to one relationship between two or more fingers of a user and multiple functions, each of the two or more fingers of the user have a different intrinsic finger feature associated therewith, the intrinsic features are features that are natural to the fingers and are not brought about by any modifications to the fingers;
(b) providing a fixed and discrete location is simultaneously associated with the multiple functions;
(c) alternating between desired functions is achieved by alternating the different fingers at the fixed and discrete location; and
(d) providing a sensor capable of obtaining a finger feature from the fixed and discrete location.

15. The method as set forth in claim 14, further comprising identifying the user of the selected finger feature.

16. The method as set forth in claim 14, further comprising determining whether the user has authorization to actuate the desired function.

17. The method as set forth in claim 14, further comprising actuating the desired function if the user has been positively identified.

18. A method for selecting functions by a user wherein the user is operating a device wherein the device is selected from the group consisting of an audio system, a mobile phone, a computer, a handheld computer, a medical device, a machine, a dashboard of a vehicle, a cockpit, a camera, a video game controller, a wireless earpiece of a cellular phone hands-free kit, and a device where the user cannot see the controls while looking through the device, comprising:
(a) providing a one to one relationship between two or more fingers of the user and multiple functions, each of the two or more fingers of the user have a different intrinsic finger feature associated therewith, the intrinsic features are features that are natural to the fingers and are not brought about by any modifications to the fingers;
(b) providing a fixed and discrete location is simultaneously associated with the multiple functions;
(c) alternating between desired functions is achieved by alternating the different fingers at the fixed and discrete location; and
(d) providing a sensor capable of obtaining a finger feature from the fixed and discrete location.and
